(19) United States
(12) Patent Application Publication
(10) Pub. No.: US 2023/0302675 A1
(43) Pub. Date: Sep. 28, 2023

(54) Cutting assembly for a vegetable cutter and a hand-held electric vegetable cutter

(71) Applicant: CHANGZHOU INFINITE LIFE ELECTRONIC COMMERCE CO., LTD., Changzhou City (CN)

(72) Inventor: Yufeng QIAN, Changzhou City (CN)

(21) Appl. No.: 17/945,250

(22) Filed: Sep. 15, 2022

(30) Foreign Application Priority Data
Mar. 28, 2022 (CN) 202220682867.X

(51) Int. Cl. B26D 1/00; A47J 43/07

(52) U.S. Cl. CPC B26D 1/0006; A47J 43/07; B26D 2001/0093

(57) ABSTRACT

The utility model discloses a cutting assembly for a vegetable cutter and a hand-held electric vegetable cutter, which falls within the field of vegetable cutting appliances. The cutting assembly for a vegetable cutter of the utility model comprises a cup body and a cutting disc, wherein the cutting disc is axially mounted in a cutter disc mounting cavity by an upper end of the cup body, the outer periphery of the cutting disc is supported on a limiting step, and a rotation connecting portion is provided at the center of the cutting disc so that the cutting disc can axially rotate in the cup body. In the cutting assembly for a vegetable cutter and the hand-held electric vegetable cutter of the utility model, the cutting disc thereof is supported in the cup body via the limiting step, and is axially and rotatably matched with the cup body, so that the cutting disc rotates smoothly and reliably in the cup body, and the assembly and disassembly thereof are simple and convenient, and the cleaning of the cutting disc and the cup body is easy, which effectively solves the problem that the existing cutter disc type cutting assembly tends to harbor dirt and scale. In addition, the necking structure is adopted in the discharging port of the cup body, so that the chopped food ingredients can be gathered towards the middle, facilitating the centralized discharge of food ingredients after being chopped, and effectively solving the problem of food ingredients splashing.

This application claims priority to Chinese Patent Application No. 202220628062.7, filed on Mar. 22, 2022, entitled “A cutting assembly for a vegetable cutter and a hand-held electric vegetable cutter”.

### TECHNICAL FIELD

The utility model relates to a kitchen vegetable cutting supplies, and more particularly to a cutting assembly for a vegetable cutter and a hand-held electric vegetable cutter.

### BACKGROUND ART

At present, there are many types of vegetable cutters on the market, and the common vegetable cutters include flat plate type vegetable cutters, hand-pulling type vegetable cutters and hand-crank type vegetable cutters. For the convenience of consumers, a small-sized electric vegetable cutter using a motor drive instead of a hand-pulled or hand-cranked drive has also been developed. Such a small-sized vegetable cutter is mainly used for chopping seasoned vegetables such as capsicum, garlic cloves, etc. and is also called a “mashed garlic cutter” or a “garlic chopper” because it is commonly used for chopping garlic cloves.

The existing small-sized vegetable cutter is mainly composed of a driving assembly and a cutting assembly, and the driving assembly is used to drive the cutting assembly to rotate and cut the food ingredient. Compared with the hand-pulling type vegetable cutter and the hand-crank type vegetable cutter, the driving assembly of the small-sized electric vegetable cutter is a motor driving mechanism, and the cutting assembly is driven to rotate and cut by the motor, so that the vegetable cutting operation is more convenient and the function of “using immediately after cutting” can also be achieved. The applicant filed patent number ZL202122207426.2 on Sep. 13, 2021, entitled “A small-sized vegetable cutter driving assembly and a multi-functional small-sized electric vegetable cutter” and patent number ZL202122205562.8, entitled “A cutter disc type cutting assembly of a vegetable cutter and a small-sized vegetable cutter”, and the driving assembly of the small-sized vegetable cutter can be used in combination with the cutter disc type cutting assembly to achieve the purpose of “using immediately after cutting”. The cutter disc type cutting assembly of the above-mentioned patent application is composed of a support ring and a cutting disc rotatably arranged in the support ring, wherein the cutting disc is confined in the support ring, which is not conducive to independent disassembly and cleaning of the cutting disc, and easily harbors dirt and scale in the rotation matching gap between the support ring and the cutting disc. For this reason, it is necessary to optimize the structural form of the cutter disc type cutting assembly described above. In addition, in order to meet the purpose of front and back mounting to achieve different cutting functions, the upper and lower structures of the support ring of the existing cutter disc type cutting assembly are the same, resulting in a larger size of the food ingredient discharging port, which is not conducive to the centralized discharge of food ingredients after being chopped, and the single-side height of the support ring cannot be too high due to the structural limitations, which is also prone to food ingredients splashing during use.

### SUMMARY

### 1. Technical Problems to be Solved by the Utility Model

The object of the utility model is to overcome the above-mentioned deficiencies of the cutter disc type cutting assembly of the existing vegetable cutter, and to provide a cutting assembly for a vegetable cutter and a hand-held electric vegetable cutter. With the technical solution of the utility model, the cutting disc is supported in the cup body via a limiting step, and is axially and rotatably matched with the cup body, so that the cutting disc rotates smoothly and reliably in the cup body, and the assembly and disassembly thereof are simple and convenient, and the cleaning of the cutting disc and the cup body is easy, which effectively solves the problem that the existing cutter disc type cutting assembly tends to harbor dirt and scale. In addition, the necking structure is adopted in the discharging port of the cup body, so that the chopped food ingredients can be gathered towards the middle, facilitating the centralized discharge of food ingredients after being chopped, and effectively solving the problem of food ingredients splashing.

### 2. Technical Solution

In order to achieve the above-mentioned object, the technical solution provided by the utility model is:
a cutting assembly for a vegetable cutter of the utility model comprises a cup body and a cutting disc, wherein the upper portion of the cup body has a connecting portion, the lower portion has a discharging portion, the bottom portion of the discharging portion has a discharging port, the inner upper portion of the cup body has a circular cutter disc mounting cavity, the cutter disc mounting cavity is provided with a limiting step, the cutting disc is axially mounted in the cutter disc mounting cavity by the upper end of the cup body, the outer periphery of the cutting disc is supported on the limiting step, and a center of the cutting disc is provided with a rotation connecting portion, so that the cutting disc can axially rotate in the cup body.

Further, the cutting disc comprises a cutter disc, an outer slip ring and a connecting ring, wherein the outer slip ring is provided on the outer periphery of the cutter disc and is used for contacting and matching with the limiting step, and the connecting ring is provided on the center of the cutter disc and is used as a rotation connecting portion for driving the cutting disc to rotate axially.

Further, a convex rib is provided on the contact surface between the outer slip ring and the limiting step.

Further, the cutter disc has two different cutting edges on the front and back sides, and the cutting disc achieves two different forms of cutting through front and back mounting in the cup body.

Further, one side of the cutter disc is provided with a sliced cutting edge, and the other side is provided with a minced grinding or shredded cutting edge.

Further, the outer slip ring and the connecting ring are both integrally injection-molded on the cutter disc made of a metal material.

Further, the discharging portion of the cup body has a necking structure in which the size of the inner cavity gradually decreases toward the discharging port.

Further, a detachable bottom cover is further provided at the discharging port of the cup body.

A hand-held electric vegetable cutter of the utility model comprises a driving assembly, a cutting assembly and a press-in piece, wherein the driving assembly comprises a housing, a handle and an electric driving mechanism, the handle is provided on the housing, the housing has a feeding channel which penetrates up and down and is eccentrically arranged, the press-in piece can extend into the feeding channel via a feeding port at the upper portion of the feeding channel, the cutting assembly is the above-mentioned cutting assembly for a vegetable cutter, and a cup body of the cutting assembly for a vegetable cutter is detachably mounted to a lower portion of a housing via a connecting portion; the cutting disc of the cutting assembly for the vegetable cutter is drivingly connected to the above-mentioned electric driving mechanism, and the disc surface of the cutting disc is opposite to the bottom portion opening position of the feeding channel.

Further, the feeding port is provided at an upward height in the upper portion of the housing.

### 3. Advantageous Effects

Compared with the known techniques, the technical solution provided by the utility model has the following beneficial effects:
(1) in a cutting assembly for a vegetable cutter and a hand-held electric vegetable cutter of the utility model, the cutting assembly comprises a cup body and a cutting disc, wherein the cutting disc is axially mounted in a cutting disc mounting cavity by the upper end of the cup body, and the outer periphery of the cutting disc is supported on a limiting step, and the center of the cutting disc is provided with a rotation connecting portion, so that the cutting disc can axially rotate in the cup body, and the cutting disc rotates smoothly and reliably in the cup body, and the assembly and disassembly are simple and convenient, and the cleaning of the cutting disc and the cup body is easy, which effectively solves the problem that the existing cutter disc type cutting assembly tends to harbor dirt and scale;
(2) in a cutting assembly for a vegetable cutter and a hand-held electric vegetable cutter of the utility model, a cutting disc comprises a cutter disc, an outer slip ring and a connecting ring, wherein the outer slip ring is provided on the outer periphery of the cutter disc and is used for contacting and matching with the limiting step, and the connecting ring is provided on the center of the cutter disc and is used as a rotation connecting portion for driving the cutting disc to rotate axially; the cutting disc has a simple structure, is easy to manufacture, and can make the cutting disc rotate smoothly and reliably, and has a higher cutting efficiency;
(3) in a cutting assembly for a vegetable cutter and a hand-held electric vegetable cutter of the utility model, a convex rib is provided on the contact surface between the outer slip ring and the limiting step, and the convex rib can reduce the contact surface between the outer slip ring and the limiting step and reduce sliding friction therebetween, so that the rotation of a cutting disc is more stable and efficient, and the rotation noise of the cutting disc is reduced;
(4) in a cutting assembly for a vegetable cutter and a hand-held electric vegetable cutter of the utility model, the cutter disc has two different cutting edges on the front and back sides, and the cutting disc achieves two different forms of cutting through front and back mounting in the cup body, and two functions can be realized on one cutting assembly, so that the vegetable cutter has a more abundant chopping function, and meets the diversified needs of consumers for food ingredient processing;
(5) in a cutting assembly for a vegetable cutter and a hand-held electric vegetable cutter of the utility model, an outer slip ring and a connecting ring are both integrally injection-molded on the cutter disc made of a metal material, which is convenient to manufacture and has a higher dimensional accuracy of cutting disc;
(6) in a cutting assembly for a vegetable cutter and a hand-held electric vegetable cutter of the utility model, the discharging portion of the cup body has a necking structure in which the size of the inner cavity gradually decreases toward the discharging port, so that the chopped food ingredients can be gathered towards the middle, facilitating the centralized discharge of food ingredients after being chopped, and effectively solving the problem of food ingredients splashing;
(7) in a cutting assembly for a vegetable cutter and a hand-held electric vegetable cutter of the utility model, a detachable bottom cover is further provided at the discharging port of the cup body, and a consumer can flexibly choose whether to use same with a cover; when the bottom cover is detached for use, the chopped food ingredient can be directly discharged from the bottom portion discharging port, with the effect of “using immediately after cutting”; when the bottom cover is assembled for use, the cup body is a closed space, and the chopped food ingredient can be retained in the cup body, so that the situation of external splashing during the chopping of the food ingredient can be effectively prevented;
(8) in a hand-held electric vegetable cutter of the utility model, it uses an electric drive and is operated by a hand-held handle, feeds food ingredients through a feeding channel, presses down the food ingredients by a press-in piece so as to stably bear against a cutting disc, is simple and safe in operation, and can directly put the chopped food ingredients into a cooking appliance through a discharging port of a cup body, achieving the object of “using immediately after cutting” and improving health and hygiene;
(9) in a hand-held electric vegetable cutter of the utility model, the feeding port is provided at an upward height in the upper portion of the housing, which is beneficial to increase the single feeding amount of food ingredients, thereby increasing the single discharging amount of the vegetable cutter.

### BRIEF DESCRIPTION OF THE DRAWINGS

FIG. 1 is a three-dimensional structure schematic diagram of an assembled state of a cutting assembly for a vegetable cutter of the utility model;

FIG. 2 is a sectional structure schematic diagram of an assembled state of a cutting assembly for a vegetable cutter of the utility model;

FIG. 3 is a partially enlarged schematic diagram at K in FIG. 2;

FIG. 4 is a three-dimensional structure schematic diagram of a disassembled state of a cutting assembly for a vegetable cutter of the utility model;

FIG. 5 is a cross-sectional structure schematic diagram of a cup body in a cutting assembly for a vegetable cutter of the utility model;

FIG. 6 is a three-dimensional structure schematic diagram of a cutting disc in a cutting assembly for a vegetable cutter of the utility model;

FIG. 7 is a sectional structure schematic diagram of a cutting assembly for a vegetable cutter with a bottom cover of the utility model;

FIG. 8 is a schematic diagram of a disassembled state of a hand-held electric vegetable cutter of the utility model;

FIG. 9 is a three-dimensional structure schematic diagram of an assembled state of a hand-held electric vegetable cutter of the utility model;

FIG. 10 is a cross-sectional structure schematic diagram of an assembled state of a hand-held electric vegetable cutter of the utility model;

FIG. 11 is a cross-sectional structure schematic diagram of a hand-held electric vegetable cutter with a bottom cover of the utility model.

Explanation of the reference numerals in the schematic diagram:

1. cup body; 1-1. connecting portion; 1-1-1. snap; 1-2. discharging portion; 1-2-1. discharging port; 1-3. limiting step; 2. cutting disc; 2-1. cutter disc; 2-1a. sliced cutting edge; 2-1b. minced grinding or shredded cutting edge; 2-2. outer slip ring; 2-2-1. convex rib; 2-3. connecting ring; 2-3-1. connecting hole; 3. driving assembly; 3-1. housing; 3-1-1. rotating clamping groove; 3-2. feeding port; 3-3. handle; 3-3-1. charging port; 3-4. switch; 3-5. feeding channel; 3-6. driving motor; 3-7. battery; 3-8. connecting column; 4. press-in piece; 5. bottom cover.

### DETAILED DESCRIPTION

In order to further understand the contents of the utility model, the utility model is described in detail with reference to the drawings and embodiments.

### Embodiment

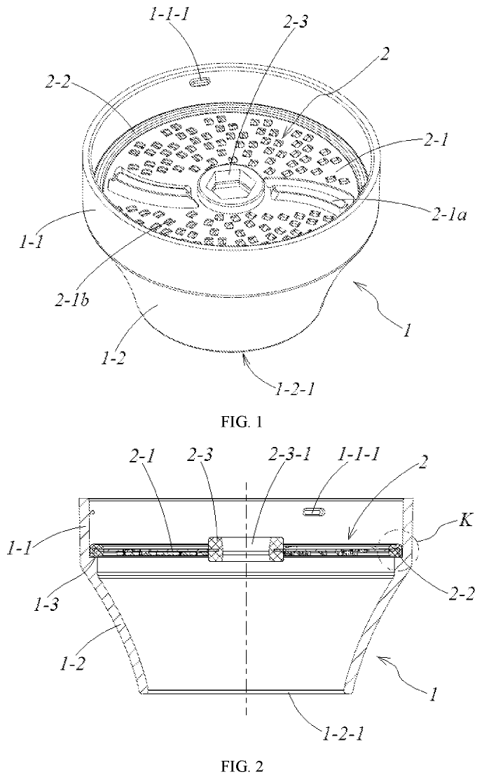

Referring to FIGS. 1 to 6, a cutting assembly for a vegetable cutter of the embodiment comprises a cup body 1 and a cutting disc 2, wherein the disc surface of the cutting disc 2 has several cutting edges, and the cutting disc 2 can rotate axially in the cup body 1, and the food ingredients are chopped by the cutting edges. The upper portion of the cup body 1 has a connecting portion 1-1, and can be connected to the vegetable cutter via the connecting portion 1-1; the lower portion of the cup body 1 has a discharging portion 1-2, and the bottom portion of the discharging portion 1-2 has a discharging port 1-2-1, and the chopped food ingredients are directly discharged from the discharging port 1-2-1. The upper portion of the inner side of the cup body 1 has a circular cutter disc mounting cavity, the cutter disc mounting cavity is provided with a limiting step 1-3, the cutting disc 2 is axially mounted in the cutting disc mounting cavity by the upper end of the cup body 1, the outer periphery of the cutting disc 2 is supported on the limiting step 1-3, the cutting disc 2 is supported and limited by the limiting step 1-3, and can rotate freely on the limiting step 1-3, and a center of the cutting disc 2 is provided with a rotation connecting portion, and the rotation connecting portion is used for driving connection with the driving mechanism of the vegetable cutter, so that the cutting disc 2 can rotate axially in the cup body 1. With the above-mentioned cutting assembly, the cutting disc 2 rotates smoothly and reliably in the cup body 1, and the assembly and disassembly are simple and convenient, and the cleaning of the cutting disc 2 and the cup body 1 is easy, which effectively solves the problem that the existing cutter disc type cutting assembly tends to harbor dirt and scale. When being cleaned, the cup body 1 is detached from the vegetable cutter, and the cutting disc 2 is taken out from the cup body 1 and directly rinsed or brushed, so as to avoid the breeding of bacteria on the cutting disc 2.

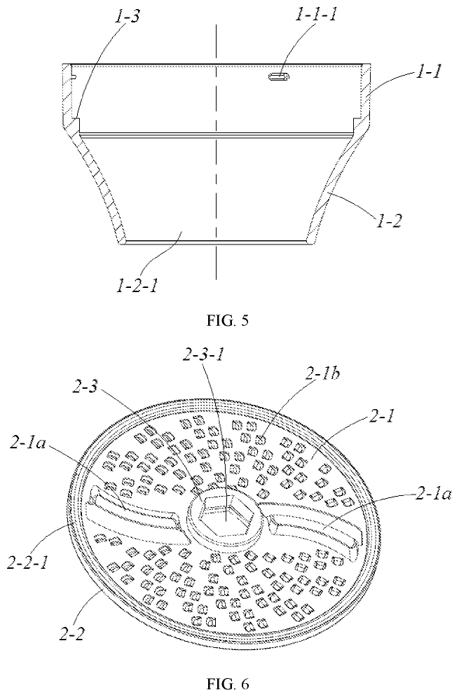

As shown in FIGS. 4 and 6, in the embodiment, the above-mentioned cutting disc 2 comprises a cutter disc 2-1, an outer slip ring 2-2 and a connecting ring 2-3, wherein the outer slip ring 2-2 is provided on an outer periphery of the cutter disc 2-1 and is used for contacting and matching with the limiting step 1-3, and the connecting ring 2-3 is provided on the center of the cutter disc 2-1 and is used as a rotation connecting portion for driving the cutting disc 2 to rotate axially. The cutting disc 2 has a simple structure and is easy to manufacture, and the outer slip ring 2-2 is smooth and wear-resistant, so that the cutting disc 2 can rotate smoothly and stably, and the cutting efficiency is higher. In order to facilitate the connection between the cutting disc 2 and the vegetable cutter driving mechanism, a connecting hole 2-3-1 may be provided in the center of the connecting ring 2-3, and the shape of the connecting hole 2-3-1 is adapted to the cross-sectional shape of the output shaft of the vegetable cutter driving mechanism, such as a regular hexagonal connecting hole shown in FIG. 6, etc. Specifically, the outer slip ring 2-2 and the connecting ring 2-3 are both integrally injection-molded on the cutter disc 2-1 made of a metal material, and the cutter disc 2-1 is preferably made of a stainless steel material. The outer slip ring 2-2 and the connecting ring 2-3 are integrally injection-molded by using the cutter disc 2-1 as an insert, the machining and manufacturing are convenient, and the dimensional accuracy of the manufactured cutting disc 2 is higher; in addition, the circumference of the cutting disc 2 is smooth and round, and the assembly and disassembly operations are safer. The outer slip ring 2-2 made of plastic is contacting and matching with the limiting step 1-3 to effectively reduce the wear between the two.

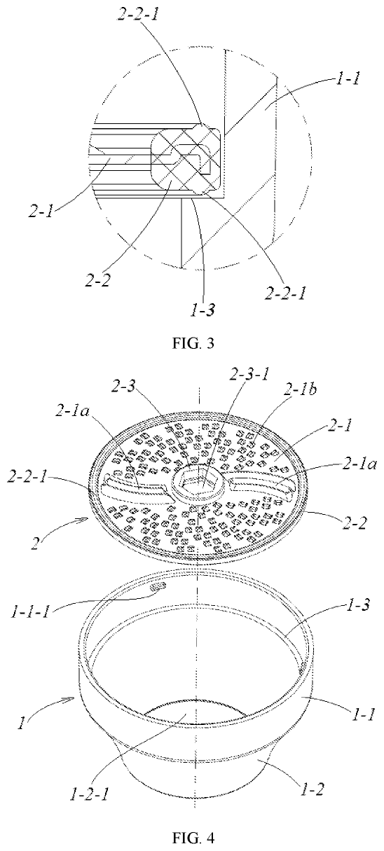

As shown in FIG. 3, in the embodiment, in order to further reduce the sliding friction between the outer slip ring 2-2 and the limiting step 1-3, a convex rib 2-2-1 is provided on the contact surface between the outer slip ring 2-2 and the limiting step 1-3, wherein the convex rib 2-2-1 can be provided on the outer slip ring 2-2 and can also be provided on the limiting step 1-3; and the convex rib 2-2-1 can reduce the contact surface between the outer slip ring 2-2 and the limiting step 1-3 and reduce the sliding friction between the two, so that the rotation of a cutting disc 2 is more stable and efficient, and the rotation noise of the cutting disc 2 is reduced. Further, as shown in FIG. 6, in the embodiment, the cutter disc 2-1 has two different cutting edges on the front and back sides, and the cutting disc 2 achieves two different forms of cutting through front and back mounting in the cup body 1, and two functions can be realized on one cutting assembly, so that the vegetable cutter has a more abundant chopping function, and meets the diversified needs of consumers for food ingredient processing. Specifically, a sliced cutting edge 2-1a for slicing is provided on one side of the cutter disc 2-1, the sliced cutting edge 2-1a can be provided with two groups on the cutter disc 2-1 in a centrosymmetric manner, and the food ingredient can be sliced using the sliced cutting edge 2-1a, such as cutting garlic slices, etc.; the other side of the cutter disc 2-1 is provided with a minced grinding or shredded cutting edge 2-1b, wherein the minced grinding edge is a raised tongue structure protruding upwards formed by punching on the cutter disc 2-1, and can grind the food ingredients, such as cutting minced garlic, etc. and the shredded cutting edge is a cutting hole formed by punching on the cutter disc 2-1, and can realize the shredding of food ingredients. Of course, other cutting edge structures can also be provided on the cutter disc 2-1 according to the needs of different functions, and the specific choice can be made according to the needs of consumers.

As shown in FIG. 2, FIG. 4 and FIG. 5, in the embodiment, the discharging portion 1-2 of the cup body 1 described above has a necking structure in which the size of the inner cavity gradually decreases toward the discharging port 1-2-1, so that the discharging portion 1-2 as a whole has a trumpet-like structure that is large at the top and small at the bottom. In this way, the chopped food ingredients can be gathered towards the middle and discharged from the discharging portion 1-2, facilitating the centralized discharge of food ingredients after being chopped, and effectively solving the problem of food ingredients splashing. The whole cup body 1 can adopt a revolving body structure, which is simple in structure and easy to manufacture. The cup body 1 is preferably made of a transparent material, so that the chopping of the food ingredients and the attachment of the food ingredients in the cup body 1 are easily and directly observed, so that the use of the vegetable cutter is more flexible and convenient.

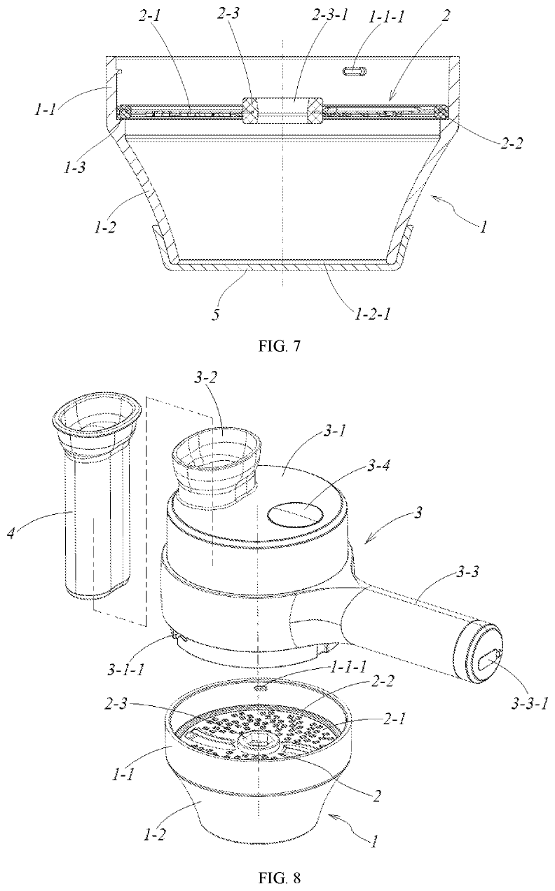

As shown in FIG. 7, as an alternative embodiment, a detachable bottom cover 5 is further provided at the discharging port 1-2-1 of the cup body 1, wherein the bottom cover 5 can close the discharging port 1-2-1 of the cup body 1, and the connection between the bottom cover 5 and the bottom portion of the cup body 1 can adopt an existing structure, such as a commonly used screwing connection structure, and the connection or detachment between the bottom cover 5 and the cup body 1 can be achieved by rotating the bottom cover 5. Through the arrangement of the bottom cover 5, a consumer can flexibly choose whether to use the bottom cover or not, and when the bottom cover 5 is detached for use, the chopped food ingredient can be directly discharged from the bottom portion discharging port 1-2-1, with the effect of “using immediately after cutting”; when the bottom cover 5 is assembled for use, the cup body 1 is a closed space, and the chopped food ingredient can be retained in the cup body 1, so that the situation of external splashing during the chopping of the food ingredient can be effectively prevented.

As shown in FIGS. 8, 9 and 10, the embodiment also relates to a hand-held electric vegetable cutter, the vegetable cutter comprising a driving assembly 3, a cutting assembly and a press-in piece 4, the driving assembly 3 comprising a housing 3-1, a handle 3-3 and an electric driving mechanism, wherein the handle 3-3 is provided on the housing 3-1, preferably the handle 3-3 is provided on one side of the vegetable cutter for facilitating hand-held operation, the housing 3-1 has a feeding channel 3-5 which penetrates up and down and is eccentrically arranged, and the feeding channel 3-5 is preferably provided on one side away from the handle 3-3; the press-in piece 4 can extend into the feeding channel 3-5 via the feeding port 3-2 at the upper portion of the feeding channel 3-5, the cutting assembly is the above-mentioned cutting assembly for a vegetable cutter, the cup body 1 of the cutting assembly for a vegetable cutter is detachably mounted to the lower portion of the housing 3-1 via the connecting portion 1-1, the cutting disc 2 of the cutting assembly for a vegetable cutter is drivingly connected to the above-mentioned electric driving mechanism, and the disc surface of the cutting disc 2 is opposite to a bottom portion opening position of the feeding channel 3-5. When in use, the food ingredient is placed into the feeding channel 3-5 from the feeding port 3-2, and then the food ingredient in the feeding channel 3-5 is pressed by the press-in piece 4, the electric driving mechanism drives the cutting disc 2 to rotate to shred the food ingredient, and the chopped food ingredient is discharged from the lower end of the cutting disc 2 and directly discharged through the discharging portion 1-2. The above-mentioned electric driving mechanism comprises a switch 3-4, a driving motor 3-6, a battery 3-7 and a control circuit board, wherein the control circuit board is electrically connected to the switch 3-4, the driving motor 3-6 and the battery 3-7 respectively, the battery 3-7 is mounted in the handle 3-3, a charging port 3-3-1 can be provided at the end portion of the handle 3-3, the driving motor 3-6 and the control circuit board are mounted inside the housing 3-1, and a connecting column 3-8 adapted to the connecting hole 2-3-1 on the cutting disc 2 is provided on the output shaft of the driving motor 3-6; a switch 3-4 can be provided at the top portion of the housing 3-1 near the handle 3-3. When in use, the handle 3-3 is held, the switch 3-4 is pressed to control the driving motor 3-6 to work, and the driving motor 3-6 drives the cutting disc 2 to rotate via the connecting column 3-8.

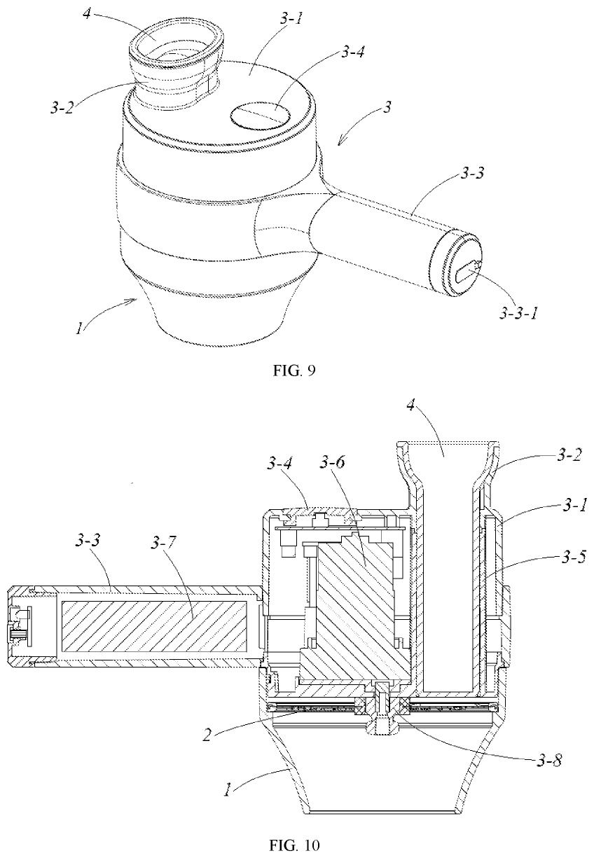

In addition, as shown in FIG. 8, FIG. 9 and FIG. 10, in the embodiment, the feeding port 3-2 is provided at an upward height in the upper portion of the housing 3-1, and the feeding port 3-2 may be provided with a flared structure to facilitate the feeding of the food ingredient. The design of the heightened feeding port 3-2 is adopted to increase the single feeding amount of food ingredients, thereby increasing the single discharging amount of the vegetable cutter.

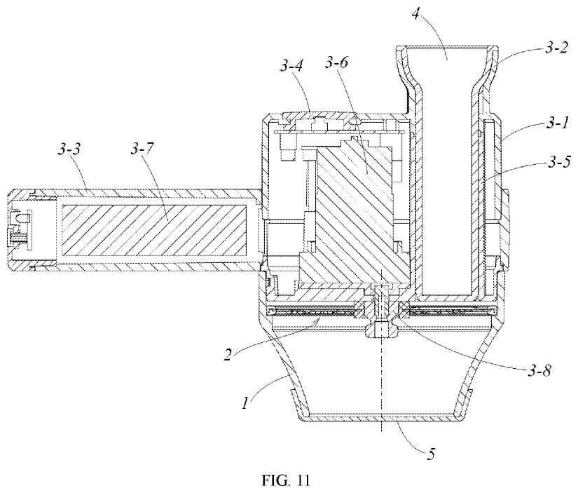

As shown in FIG. 8, the cup body 1 and the driving assembly 3 can be connected using a rotating clamping structure, wherein the rotating clamping structure comprises a rotating clamping groove 3-1-1 provided on the outer periphery of the lower portion of the housing 3-1 and a snap 1-1-1 provided on the inner wall of the connecting portion 1-1 of the cup body 1; during assembly, the cup body 1 is butted to the lower portion of the housing 3-1, and after being plugged in place, the cup body 1 can be rotated clockwise to realize the connection between the cup body 1 and the driving assembly 3 using the snap 1-1-1 and the rotating clamping groove 3-1-1, and the assembly and disassembly are simple and flexible, and the operation is convenient. FIG. 11 shows a hand-held electric vegetable cutter with a bottom cover 5 at the bottom portion of the cup body 1. After the bottom cover 5 is mounted, the chopped food ingredient can be contained in the cup body 1. When in use, the bottom cover 5 can be opened, the chopped food ingredient can be poured out, preventing the food ingredient from external splashing in use, providing more choices of use state for consumers.

As regard to other specific structures of the above-mentioned driving assembly 3, reference can be made to patent application No. ZL202122207426.2, entitled “A small-sized vegetable cutter driving assembly and a multi-functional small-sized electric vegetable cutter”, and the description thereof will not be repeated here.

In order to further understand the technical contents of the utility model, the use process of the cutting assembly for a vegetable cutter and the hand-held electric vegetable cutter of the utility model will now be further described with reference to FIGS. 8 and 9.

When in use, according to the needs of the specific shredding form, a cutting edge corresponding to the form of the cutting disc 2 is mounted upwards in the cup body 1, so that the outer slip ring 2-2 of the outer periphery of the cutting disc 2 is supported on the limiting step 1-3 in the cup body 1; the cup body 1 is mounted on the lower portion of the driving assembly 3 via the connecting portion 1-1, and at this time, the connecting column 3-8 in the driving assembly 3 is just inserted into the connecting hole 2-3-1 of the cutting disc 2, completing the assembly of the vegetable cutter. After that, the handle 3-3 is held by one hand, the block food ingredients such as garlic cloves are added into the feeding channel 3-5 through the feeding port 3-2, and the food ingredients in the feeding channel 3-5 are pressed down by the press-in piece 4, so that the food ingredients have a certain downward pressure; the driving motor 3-6 is then activated by the switch 3-4, and the driving motor 3-6 drives the cutting disc 2 to rotate and use the cutting edge thereon to chop the food ingredient. The chopped food ingredient enters the discharging portion 1-2 of the lower portion of the cup body 1 after passing through the cutting edge, and since the discharging portion 1-2 has a trumpet-like shape that is large at the top and small at the bottom, the food ingredient will gather to the discharging port 1-2-1 and be directly discharged from the discharging port 1-2-1, using immediately after cutting. After use, the cup body 1 is detached from the driving assembly 3, and the cutting disc 2 is taken out from the cup body 1, and the cup body 1 and the cutting disc 2 are cleaned respectively, so that the cutting disc 2 is kept clean and sanitary. In the use with the cover shown in FIG. 11, the chopped food ingredient is gathered in the cup body 1, no food ingredient is sprinkled during the shredding of the food ingredient, after which the bottom cover 5 can be opened to pour the food ingredient according to the amount of the food ingredient.

In the cutting assembly for a vegetable cutter and the hand-held electric vegetable cutter of the utility model, the cutting disc thereof is supported in the cup body via the limiting step, and is axially and rotatably matched with the cup body, so that the cutting disc rotates smoothly and reliably in the cup body, and the assembly and disassembly thereof are simple and convenient, and the cleaning of the cutting disc and the cup body is easy, which effectively solves the problem that the existing cutter disc type cutting assembly tends to harbor dirt and scale. In addition, the necking structure is adopted in the discharging port of the cup body, so that the chopped food ingredients can be gathered towards the middle, facilitating the centralized discharge of food ingredients after being chopped, and effectively solving the problem of food ingredients splashing. Optionally, by providing a bottom cover at the bottom portion of the cup body, there is flexibility in selecting whether to use with the cover, providing more choices of use state for consumers.

The utility model and its embodiments have been schematically described above, the description is not restrictive, and the drawing shows only one embodiment of the utility model, and the actual structure is not limited thereto. Hence, a person of ordinary skill in the art would have been inspired to design a structural mode and an embodiment similar to the technical solution without departing from the inventive purpose of the utility model, and all these should fall within the scope of the utility model.

1. A cutting assembly for a vegetable cutter, comprising a cup body and a cutting disc, wherein an upper portion of the cup body has a connecting portion, a lower portion has a discharging portion, a bottom portion of the discharging portion has a discharging port, an inner upper portion of the cup body has a circular cutter disc mounting cavity, the cutter disc mounting cavity is provided with a limiting step, the cutting disc is axially mounted in the cutter disc mounting cavity by an upper end of the cup body, an outer periphery of the cutting disc is supported on the limiting step, and a center of the cutting disc is provided with a rotation connecting portion, so that the cutting disc can axially rotate in the cup body.

2. The cutting assembly for a vegetable cutter according to claim 1, wherein the cutting disc comprises a cutter disc, an outer slip ring and a connecting ring, wherein the outer slip ring is provided on an outer periphery of the cutter disc and is used for contacting and matching with the limiting step, and the connecting ring is provided on the center of the cutter disc and is used as a rotation connecting portion for driving the cutting disc to rotate axially.

3. The cutting assembly for a vegetable cutter according to claim 2, wherein a convex rib is provided on the contact surface between the outer slip ring and the limiting step.

4. The cutting assembly for a vegetable cutter according to claim 2, wherein the cutter disc has two different cutting edges on the front and back sides, and the cutting disc achieves two different forms of cutting through front and back mounting in the cup body.

5. The cutting assembly for a vegetable cutter according to claim 4, wherein one side of the cutter disc is provided with a sliced cutting edge, and the other side is provided with a minced grinding or shredded cutting edge.

6. The cutting assembly for a vegetable cutter according to claim 2, wherein the outer slip ring and the connecting ring are both integrally injection-molded on the cutter disc made of a metal material.

7. The cutting assembly for a vegetable cutter according to claim 1, wherein the discharging portion of the cup body has a necking structure in which the size of the inner cavity gradually decreases toward the discharging port.

8. The cutting assembly for a vegetable cutter according to claim 1, wherein a detachable bottom cover is further provided at the discharging port of the cup body.

9. A hand-held electric vegetable cutter, comprising a driving assembly, a cutting assembly and a press-in piece, wherein the driving assembly comprises a housing, a handle and an electric driving mechanism, the handle is provided on the housing, the housing has a feeding channel which penetrates up and down and is eccentrically arranged, and the press-in piece can extend into the feeding channel via a feeding port at the upper portion of the feeding channel, wherein the cutting assembly is the cutting assembly for a vegetable cutter according to claim 1, wherein a cup body of the cutting assembly for a vegetable cutter is detachably mounted to a lower portion of a housing via a connecting portion, a cutting disc of the cutting assembly for a vegetable cutter is drivingly connected to the above-mentioned electric driving mechanism, and a disc surface of the cutting disc is opposite to a bottom portion opening position of the feeding channel.

10. The hand-held electric vegetable cutter according to claim 9, wherein the feeding port is provided at an upward height in the upper portion of the housing.
